(19) United States
(12) Patent Application Publication
(10) Pub. No.: US 2021/0364992 A1
(43) Pub. Date: Nov. 25, 2021

(54) PROTECTIVE CASE FOR SMART WATCH

(71) Applicants: Shih-Cheng Yang, Changhua (TW); Tsuo-Fei Mao, Changhua (TW)

(72) Inventors: Shih-Cheng Yang, Changhua (TW); Tsuo-Fei Mao, Changhua (TW)

(73) Assignee: 3DWIND TECHNOLOGY CO., LTD., CHANGHUA CITY (TW)

(21) Appl. No.: 17/326,224

(22) Filed: May 20, 2021

(30) Foreign Application Priority Data
May 21, 2020 (TW) 109116936

(51) Int. Cl. G04G 17/08; H04R 1/34; G04G 9/00

(52) U.S. Cl. CPC G04G 17/08; G04G 9/007; H04R 1/345

(57) ABSTRACT

A protective case for smart watch may include a main body disposed around a smart watch to provide the elastic protection effect. The main body formed in a frame shape has two connecting edges, a controlling edge, and an audio edge, which are formed with the same thickness. The two connecting edges are formed in parallel, and each of the connecting edges has an engaging slot to couple with the watch strap of the smart watch. An audio recess concavely formed on an inner surface of the audio edge is configured to couple with a lateral side of the smart watch. The audio recess has a bottom portion communicated with the location of the speaker of the smart watch, and the audio recess is extended to the display of the smart watch to form a top opening.

### FIELD OF THE INVENTION

The present invention relates to a protective case for smart watch and more particularly to an easy-manufacturing protective case for smart watch with improved sound output.

### BACKGROUND OF THE INVENTION

As the inventor's previous application “Protective case for smart watch” disclosed in Taiwan Patent (Certificate No. 1685310) on Feb. 21, 2020, the protective case for smart watch may include a first side edge and a second side edge which are formed in parallel, and the thickness of the first side edge is smaller than that of the second side edge. Moreover, the second side edge has at least a sound opening that enables the sound of the smart watch's speaker to the external environment without the degrading of sound quality.

However, the conventional protective case for smart watch has following disadvantages: (i) with the sound opening, the thickness of the second side edge needs to be increased, and the second side edge is obviously thicker than the first side edge, which not only increases the manufacturing cost but also affects the appearance of the protective case; and (ii) the sound opening comprises a start end and an output end, and the start end is connected to the spacing of the watch base while the output end located on the surface of the second side edge is exposed to the external environment, and the structure of narrow sound opening makes the manufacturing process more difficult and significant affect the yield rate. Therefore, there remains a need for a new and improved design for a protective case for smart watch to overcome the problems presented above.

### SUMMARY OF THE INVENTION

The present invention provides a protective case for smart watch comprising a main body which is disposed around a smart watch to provide the elastic protection effect. The main body formed in a frame shape has two connecting edges, a controlling edge, and an audio edge, which are formed with the same thickness. The two connecting edges are formed in parallel, and each of the connecting edges has an engaging slot to couple with the watch strap of the smart watch. An audio recess concavely formed on an inner surface of the audio edge is configured to couple with a lateral side of the smart watch. The audio recess has a bottom portion communicated with the location of the speaker of the smart watch, and the audio recess is extended to the display of the smart watch to form a top opening, and the area of the bottom portion is larger than that of the top opening.

In one embodiment, the audio recess comprises a hollow surface faced toward the smart watch, and the audio recess is adapted to cover the smart watch through the hollow surface so as to form the top opening in unidirectional configuration.

In another embodiment, the length of the bottom portion is longer than the length of the top opening.

In still another embodiment, the main body comprises an upper arc ring portion and a lower arc ring portion respectively at the positions corresponding to the display and the backside of the smart watch, and the upper arc ring portion is formed at the outer side of the top opening, and while the height is defined as the backside toward the display of the smart watch, the position of the upper arc ring portion is higher than that of the top opening of the audio recess.

In a further embodiment, the height between the top opening and the bottom portion is between one-half to three-quarters of the height between the upper arc ring portion and the lower arc ring portion.

In still a further embodiment, the thinnest position of the audio edge is located at the position corresponding to the audio recess, which has the thickness thinner than the thickness of the audio recess.

In a preferred embodiment, the audio recess is formed into arc-shape along the lateral side of the smart watch.

In another preferred embodiment, the controlling edge of the main body comprises at least a turn-button hole and a reboot hole at the positions corresponding to the digital crown and the reboot button of the smart watch, and the digital crown of the smart watch is exposed out from the turn-button hole, and when the smart watch crashed, the user is configured to forced-reboot the smart watch by pressing the reboot button through the reboot hole.

In an advantageous embodiment, a round first recess is formed at the inner surface of the controlling edge, so that the position on the outer surface of the controlling edge corresponding to the first recess is adapted to be easily pressed and deformed, so as to protect the buttons of the smart watch and to improve the practicability of the protective case.

In another advantageous embodiment, a plurality of first grooves, which are formed in parallel in the audio recess along the direction from the bottom portion to the top opening, are adapted to enhance the sound charity and the transmission distance of sound.

Comparing with conventional protective case for smart watch, the present invention is advantageous because: (i) the audio recess is communicated with and located at the position corresponding to the speaker of the smart watch, and the audio recess is cooperated with the top opening which is located at the lateral side of the smart watch and faced to the display, such that the sounds and music from the smart watch is configured to output through the audio recess and the top opening, and the volume can be increased with great sound quality as the sound wave is guided in the direction; and (ii) the main body comprises the hollow surface formed between the bottom portion and the top opening of the audio recess, so that the audio recess has wide range of opening to the external environment, thus having the advantage of easy production and reducing the defective rate.

### BRIEF DESCRIPTION OF THE DRAWINGS

FIG. 1 is a three-dimensional assembly view of a protective case for smart watch of the present invention coupled on a smart watch.

FIG. 2 is a three-dimensional assembly view of the protective case for smart watch of the present invention.

FIG. 3 is a three-dimensional sectional view of the protective case for smart watch of the present invention.

FIG. 4 is a sectional view of the protective case for smart watch of the present invention when in use.

FIG. 5 is a first front schematic view illustrating an audio recess of the protective case for smart watch in the present invention.

FIG.6 is a second front schematic view illustrating the audio recess of the protective case for smart watch in the present invention.

FIG. 7 is a first sectional schematic view illustrating the audio recess of the protective case for smart watch in the present invention.

FIG. 8 is a second sectional schematic view illustrating the audio recess of the protective case for smart watch in the present invention.

FIG. 9 is a three-dimensional sectional view of a second embodiment of the protective case for smart watch in the present invention.

FIG. 10 is a schematic view of the second embodiment of the protective case for smart watch in the present invention when in use.

FIG. 11 is a schematic view of a round first recess of the protective case for smart watch in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

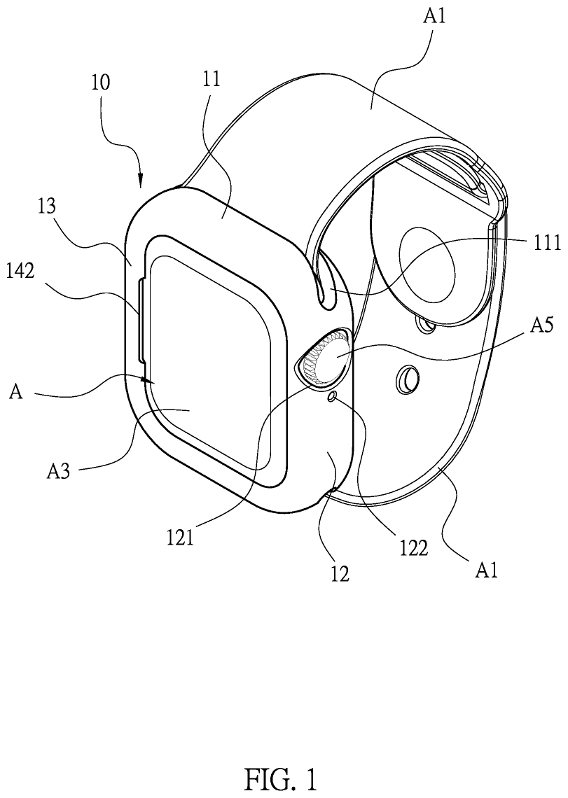

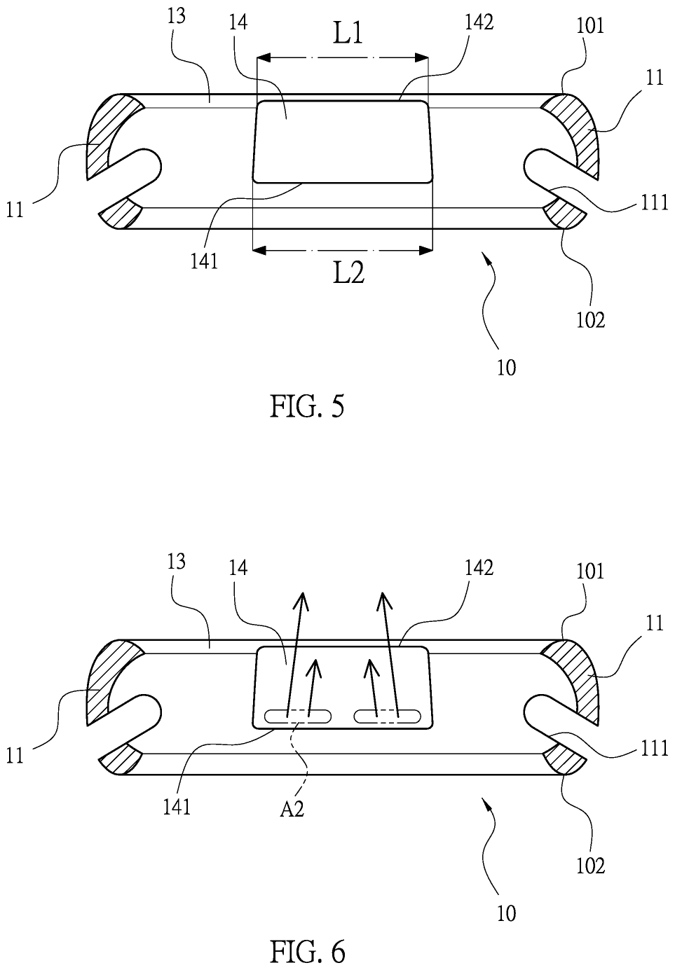

Referring to FIGS. 1 to 3, the present invention provides a protective case for smart watch comprising a main body (10) which is disposed around a smart watch (A) to provide the elastic protection effect. The main body (10) formed in a frame shape has two connecting edges (11), a controlling edge (12), and an audio edge (13), which are formed with the same thickness. The two connecting edges (11) are formed in parallel, and each of the connecting edges (11) has an engaging slot (111) to couple with the watch strap (A1) of the smart watch (A). An audio recess (14) concavely formed on an inner surface of the audio edge (13) is configured to couple with a lateral side of the smart watch (A). In addition, the audio recess (14) has a bottom portion (141) communicated with the location of the speaker (A2) of the smart watch (A), and the audio recess (14) is extended to the display (A3) of the smart watch (A) to form a top opening (142), and the area of the bottom portion (141) is larger than that of the top opening (142). As shown in FIG. 5, the length (L2) of the bottom portion (141) is longer than the length (L1) of the top opening (142). Furthermore, the audio recess (14) comprises a hollow surface (143) faced toward the smart watch (A), and the audio recess (14) is adapted to cover the smart watch (A) through the hollow surface (143) so as to form the top opening in unidirectional configuration. As a result, the audio recess (14) is adapted to not only avoid the degrading of sound quality from the speaker (A2) of the smart watch (A) but also make the manufacturing process of the protective case easier.

In actual application, referring to FIGS. 1 to 6, the main body (10) is formed integrally to have the connecting edges (11), the controlling edge (12), and the audio edge (13). The audio recess (14) of the audio edge (13) is configured to be disposed on the edge of the smart watch (A) to provide the elastic protection effect. The audio recess (14) is communicated with and located at the position corresponding to the speaker (A2) of the smart watch (A), and the audio recess (14) is cooperated with the top opening (142) which is located at the lateral side of the smart watch (A) and faced to the display (A3), such that the sounds and music from the smart watch (A) is configured to output through the audio recess (14) and the top opening (142), and the volume can be increase with great sound quality as the sound wave is guided in the direction. Additionally, the main body (10) comprises the hollow surface (143) formed between the bottom portion (141) and the top opening (142) of the audio recess (14), so that the audio recess (14) has wide range of opening to the external environment, thus having the advantage of easy production and reducing the defective rate. Meanwhile, with the top opening (142), the four edges (11)(12)(13) of the main body (10) can have the same thickness, which makes the manufacturing process easily and keeps the good appearance of the protective case.

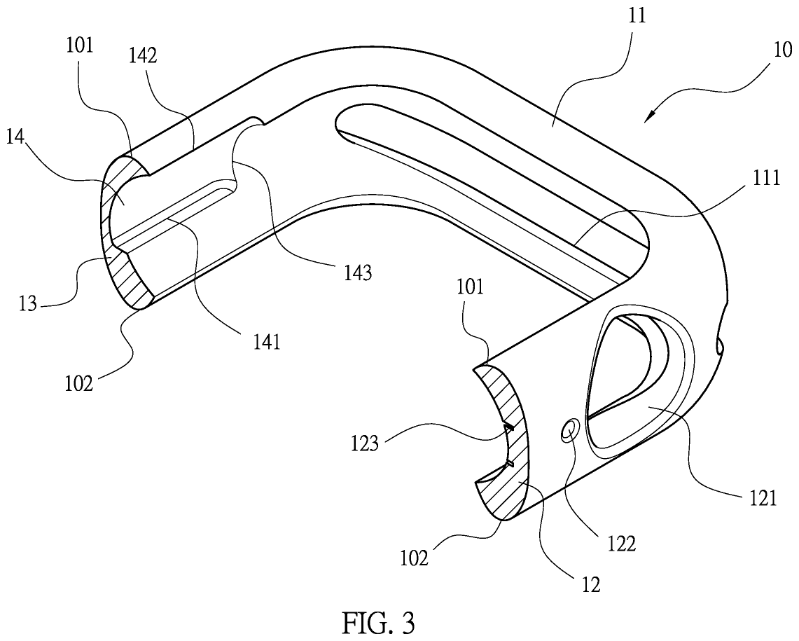

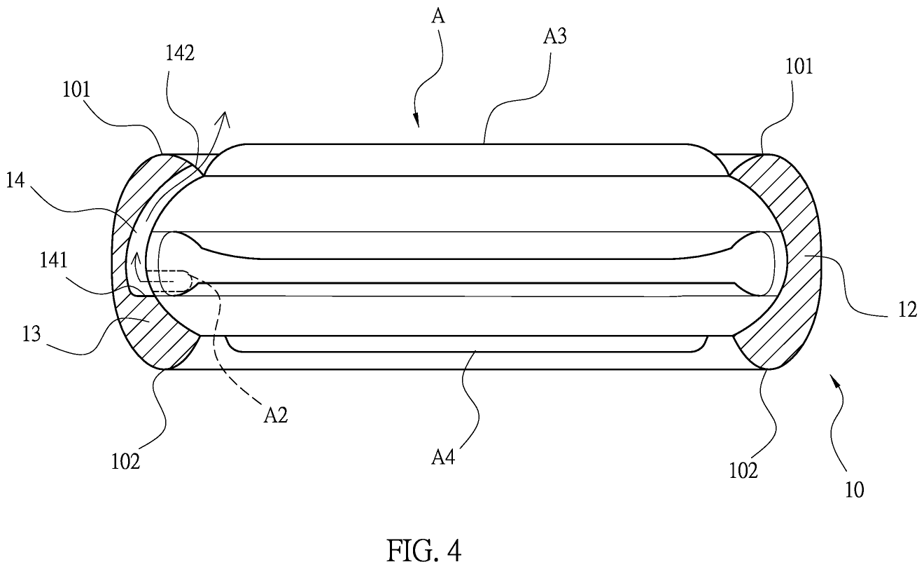

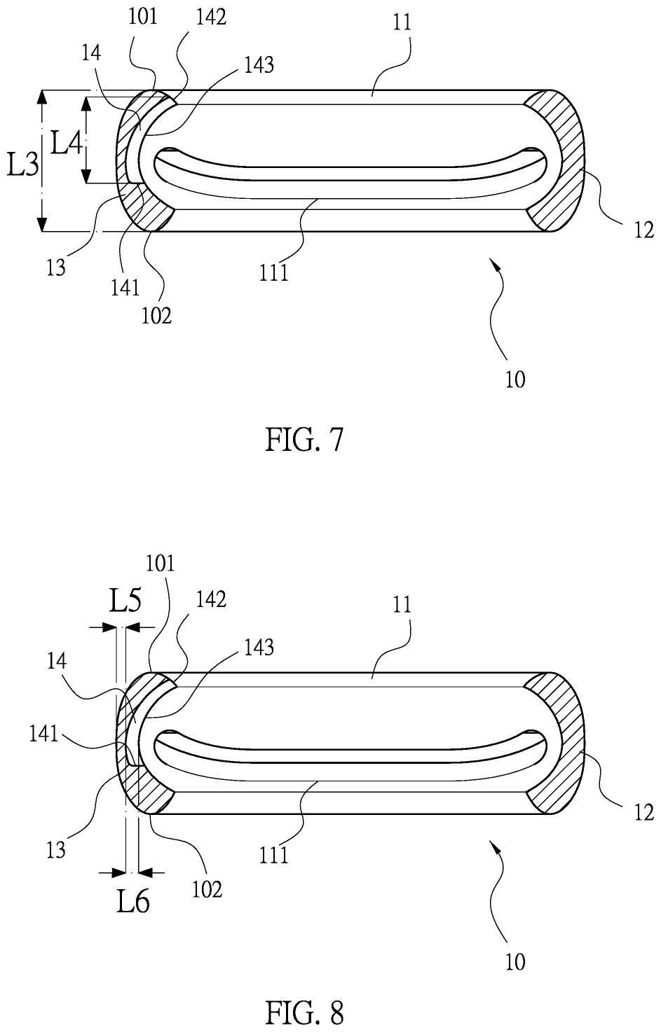

Referring to FIGS. 3 and 4, the main body (10) comprises an upper arc ring portion (101) and a lower arc ring portion (102) respectively at the positions corresponding to the display (A3) and the backside (A4) of the smart watch (A). The upper arc ring portion (101) is formed at the outer side of the top opening (142), and while the height is defined as the backside (A4) toward the display (A3) of the smart watch (A), the position of the upper arc ring portion (101) is higher than that of the top opening (142) of the audio recess (14) so as to provide the top opening (142) with sufficient anti-deformation strength, thereby preventing the top opening (142) from deformation. Moreover, as shown in FIG. 7, the height between the top opening (142) and the bottom portion (141) is between one-half to three-quarters of the height between the upper arc ring portion (101) and the lower arc ring portion (102). Also, the thinnest position (L5) of the audio edge (13) is located at the position corresponding to the audio recess (14), which has the thickness thinner than the thickness of the audio recess (L6) (as shown in FIG. 8). In addition, the audio recess (14) is formed into arc-shape along the lateral side of the smart watch (A) so as to improve the structural strength and keep the sound quality under the limited thickness of the audio edge (13).

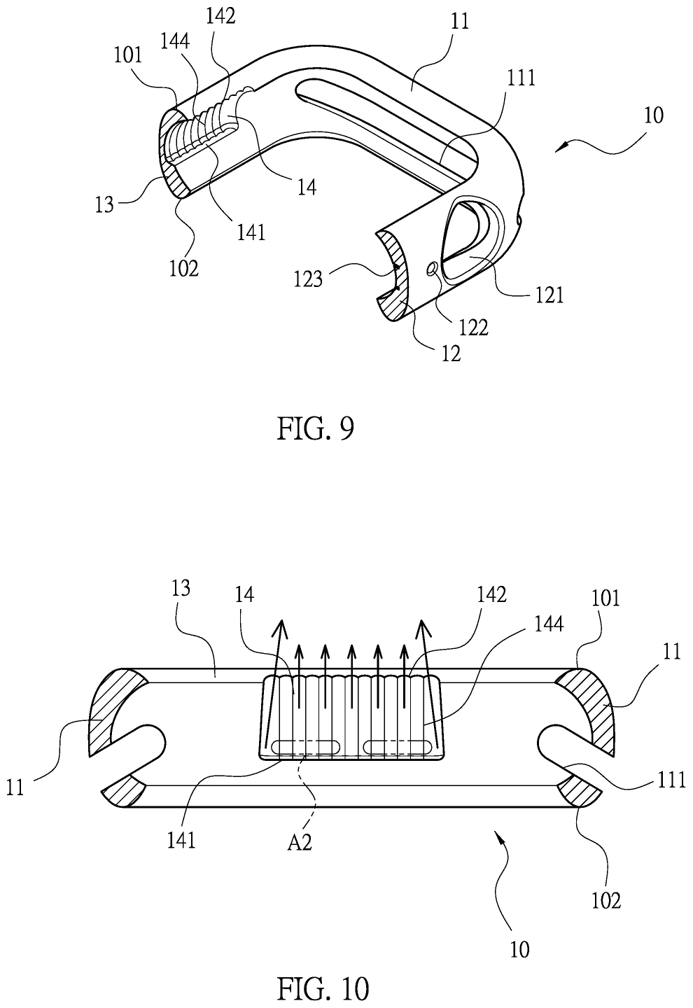

Referring to FIGS. 9 and 10, a plurality of first grooves (144), which are formed in parallel in the audio recess (14) along the direction from the bottom portion (141) to the top opening (142), are adapted to form a plurality of audio channels in the audio recess (14), so as to enhance the sound charity and the transmission distance of sound.

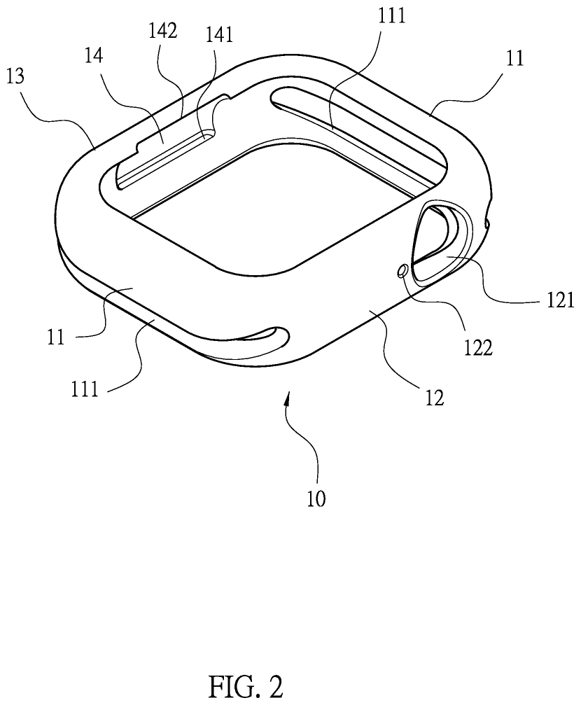

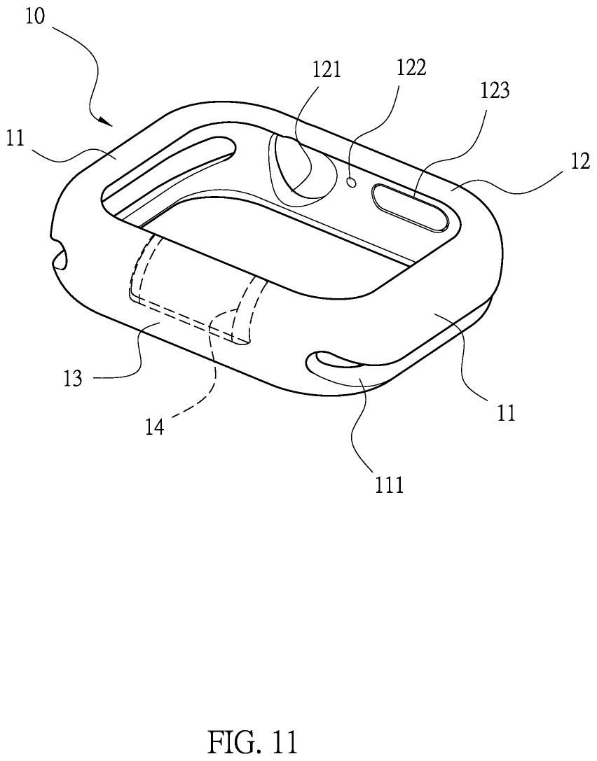

Referring to FIGS. 2 and 11, the controlling edge (12) of the main body (10) comprises at least a turn-button hole (121) and a reboot hole (122) at the positions corresponding to the digital crown (A5) and the reboot button of the smart watch (A). The digital crown (A5) of the smart watch (A) is exposed out from the turn-button hole (121), and when the smart watch (A) crashed, the user can forced-reboot the smart watch (A) by pressing the reboot button through the reboot hole (122). Additionally, a round first recess (123) is formed at the inner surface of the controlling edge (12), so that the position on the outer surface of the controlling edge (12) corresponding to the first recess (123) can be easily pressed and deformed, so as to protect the buttons of the smart watch (A) and to improve the practicability of the protective case.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A protective case for smart watch comprising a main body;
wherein the main body is disposed around a smart watch to provide the elastic protection effect; the main body formed in a frame shape has two connecting edges, a controlling edge, and an audio edge, which are formed with the same thickness; the two connecting edges are formed in parallel, and each of the connecting edges has an engaging slot to couple with the watch strap of the smart watch; an audio recess concavely formed on an inner surface of the audio edge is configured to couple with a lateral side of the smart watch;
the audio recess has a bottom portion communicated with the location of the speaker of the smart watch, and the audio recess is extended to the display of the smart watch to form a top opening; the audio recess comprises a hollow surface faced toward the smart watch, and the audio recess is adapted to cover the smart watch through the hollow surface so as to form the top opening in unidirectional configuration; the main body comprises an upper arc ring portion and a lower arc ring portion respectively at the positions corresponding to the display and the backside of the smart watch, and the upper arc ring portion is formed at the outer side of the top opening, and while the height is defined as the backside toward the display of the smart watch, the position of the upper arc ring portion is higher than that of the top opening of the audio recess; the area of the bottom portion is larger than that of the top opening; the audio recess is easily formed, and the sounds and music from the smart watch is configured to output through the audio recess and the top opening, and the volume is increased with great sound quality as the sound wave is guided in the direction by the audio recess.

2. The protective case for smart watch of claim 1, wherein the length of the bottom portion is longer than the length of the top opening.

3. The protective case for smart watch of claim 1, wherein the height between the top opening and the bottom portion is between one-half to three-quarters of the height between the upper arc ring portion and the lower arc ring portion.

4. The protective case for smart watch of claim 1, wherein the thinnest position of the audio edge is located at the position corresponding to the audio recess, which has the thickness thinner than the thickness of the audio recess.

5. The protective case for smart watch of claim 1, wherein the audio recess is formed into arc-shape along the lateral side of the smart watch.

6. The protective case for smart watch of claim 1, wherein the controlling edge of the main body comprises at least a turn-button hole and a reboot hole at the positions corresponding to the digital crown and the reboot button of the smart watch, and the digital crown of the smart watch is exposed out from the turn-button hole, and when the smart watch crashed, the user is configured to forced-reboot the smart watch by pressing the reboot button through the reboot hole.

7. The protective case for smart watch of claim 1, wherein a round first recess is formed at the inner surface of the controlling edge, so that the position on the outer surface of the controlling edge corresponding to the first recess is adapted to be easily pressed and deformed, so as to protect the buttons of the smart watch and to improve the practicability of the protective case.

8. The protective case for smart watch of claim 1, wherein a plurality of first grooves, which are formed in parallel in the audio recess along the direction from the bottom portion to the top opening, are adapted to improve the sound guidance.
